(19) United States
(12) Patent Application Publication
(10) Pub. No.: US 2020/0284344 A1
(43) Pub. Date: Sep. 10, 2020

(54) PISTON RING WITH INLAID DLC COATING AND METHOD OF MANUFACTURING

(71) Applicant: Tenneco Inc., Lake Forest, IL (US)

(72) Inventor: Blair Matthew Jenness, Grosse Pointe Park, MI (US)

(21) Appl. No.: 16/291,832

(22) Filed: Mar. 4, 2019

(51) Int. Cl. F16J 9/26; F16J 9/20

(52) U.S. Cl. CPC F16J 9/26; F16J 9/20

(57) ABSTRACT

A piston ring providing improved performance during operation, including reduction in blowby gases and improved oil control, is provided. The piston ring includes a rail disposed in a recess of a wire. The wire presents a wire outer diameter surface, the ring presents a ring outer diameter surface, and a coating including diamond-like carbon is disposed on the rail outer diameter surface. The coating is inlaid and thus an exposed sharp upper corner is present between an upper portion of the wire outer diameter surface and an upper ring surface, and an exposed sharp lower corner is present between a lower portion of the wire outer diameter surface and a lower ring surface.

### BACKGROUND OF THE INVENTION

### 1. Field of the Invention

The present invention is related generally to piston rings and methods of manufacturing piston rings.

### 2. Related Art

Internal combustion engine manufacturers are encountering increasing demands to improve engine efficiencies and performance, including, but not limited to, improving fuel economy, improving fuel combustion, reducing oil consumption, increasing the exhaust temperature for subsequent use of the heat, increasing compression loads within the cylinder bores, decreasing weight and making engines more compact. In order to satisfy one or more of these demands, many engine manufacturers have been employing advanced technologies to increase the temperature and pressure loads within the combustion chambers of their engines. Consequently, such pistons must be sealed to their respective cylinder bores with piston rings that are designed to withstand the increasingly extreme environment. Improvements to piston ring performance is desired.

### SUMMARY

One aspect of the present invention provides a piston ring for a piston of an internal combustion engine. The piston ring provides for improved performance, specifically a reduction in blowby gases and improved oil control. The piston ring includes a wire formed of a metal material extending circumferentially around a center axis. The wire presents a wire outer diameter surface which includes a recess. The piston ring also includes a rail formed of steel extending circumferentially around the center axis and disposed in the recess of the wire. The rail presents a rail outer diameter surface. A coating including diamond-like carbon is disposed on the rail outer diameter surface.

Another aspect of the invention provides a method of manufacturing a piston ring. The method comprises providing a rail formed of steel and extending circumferentially around a center axis, the rail presents a rail outer diameter surface. The method also includes disposing a coating including diamond-like carbon on the rail outer diameter surface. The method further includes providing a wire formed of a metal material and extending circumferentially around a center axis, and the wire presents a wire outer diameter surface which includes a recess. The method further includes disposing the rail in the recess of the wire.

Yet another aspect of the invention provides a piston assembly. The piston assembly comprises a piston body portion. At least one piston ring is disposed on the piston body portion. Each of the at least one piston ring includes a wire and a rail. The wire is formed of a metal material extending circumferentially around a center axis. The wire presents a wire outer diameter surface which includes a recess. A rail formed of steel extends circumferentially around the center axis and is disposed in the recess of said wire. The rail presents a rail outer diameter surface. A coating including diamond-like carbon is disposed on the rail outer diameter surface.

Another aspect of the invention includes a method of manufacturing a piston assembly. The method comprises providing a piston body portion; and disposing at least one piston ring on the piston body portion. Each of the at least one piston ring includes a wire formed of a metal material extending circumferentially around a center axis. The wire presents a wire outer diameter surface which includes a recess. A rail formed of steel and extending circumferentially around the center axis is disposed in the recess of the wire. The rail presents a rail outer diameter surface. The method further includes disposing a coating including diamond-like carbon on the rail outer diameter surface.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is top view of a piston ring according to an example embodiment;

FIG. 2 is a cross-sectional view of the piston ring according to the example embodiment;

FIG. 2A is an enlarged view of a portion of the piston ring of FIG. 2; and

FIG. 3 is a side view of a piston assembly including a piston ring according to an example embodiment.

### DESCRIPTION OF EXEMPLARY EMBODIMENTS

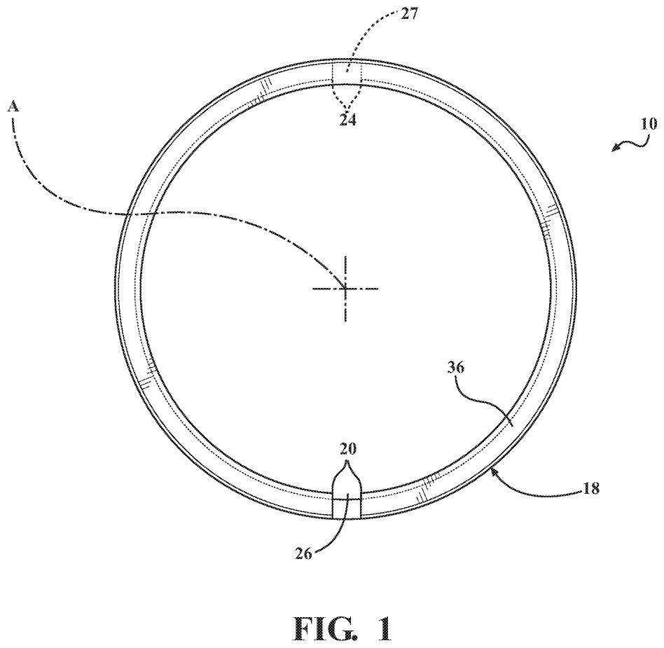

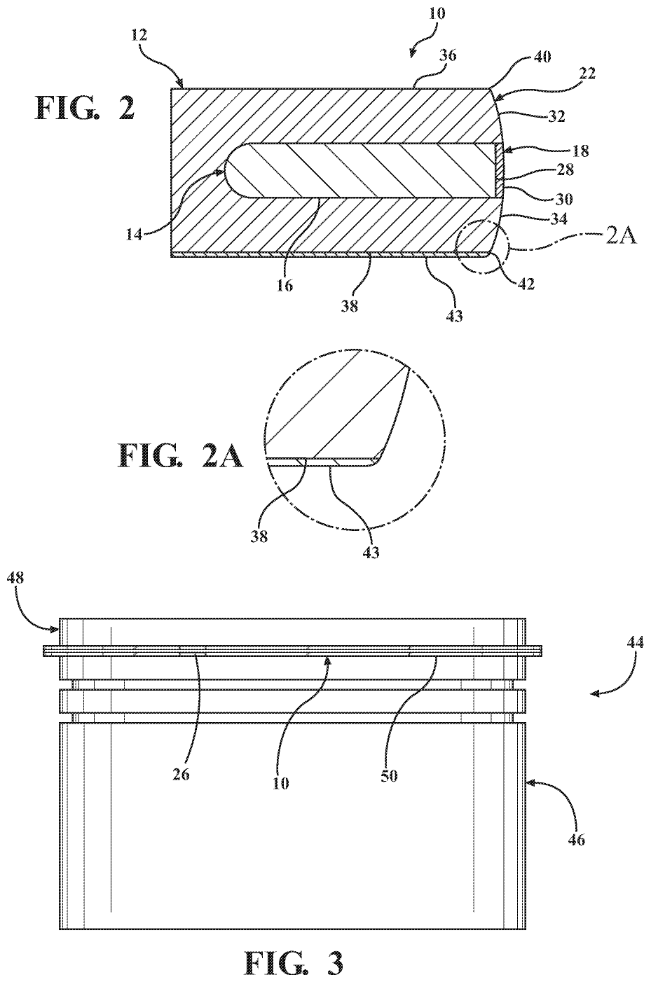

As shown in FIGS. 1-3, the invention provides a piston ring 10 for an internal combustion engine which is capable of providing improved performance during operation, including reduction in blowby gases and improved oil control. As shown in FIG. 2, the piston ring 10 has a two-piece design including a wire 12 and a rail 14. The rail 14 is disposed in a recess 16 of the wire 12. A coating 18 including diamond-like carbon is disposed on the rail 12.

The wire 12 is formed of a metal material and extends circumferentially around a center axis A between opposite wire ends 20. A wire gap 26 is located between the wire ends 20. The wire 12 presents a wire outer diameter surface 22 which includes the recess 16.

The rail 14 is formed of steel and extends circumferentially around the center axis A between opposite rail ends 24. A rail gap 27 is located between the rail ends 24. Preferably, the rail ends 24 are circumferentially misaligned aligned with the wire ends 20, and the rail gap 27 is circumferentially misaligned with the wire gap 26. For example, as shown in FIG. 1, the rail ends 24 and the rail gap 27 can be disposed 180 degrees from the wire ends 20 and the wire gap 26. Thus, the wire gap 26 and the rail gap 27 are staggered. The rail 14 also presents a rail outer diameter surface 28.

The coating 18 which includes diamond-like carbon can be referred to as a DLC coating. According to a preferred embodiment, the coating 18 is free of hydrogen. The coating 18 is disposed on the rail outer diameter surface 28, and the coating 18 presents a coating outer diameter surface 30. The coating 18 is preferably not disposed on the wire outer diameter surface 22 and thus a smaller axial higher of the ring 10 is coated, compared to rings with a coating on an entire outer diameter surface, which can increase the capacity of the DLC furnace.

As best shown in FIG. 2, the wire outer diameter surface 22 and the coating outer diameter surface 30 are outermost surfaces of the piston ring 10, and those surfaces are convex in shape. The wire outer diameter surface 22 includes an upper portion 32 spaced from a lower portion 34 by the coating outer diameter surface 30. The rail outer diameter surface 28 is disposed radially inwardly of the upper portion 32 and the lower portion 34 of the wire outer diameter surface 22. In the example embodiment, the coating outer diameter surface 30 is flush with the upper portion 32 and the lower portion 34 of the wire outer diameter surface 22.

The wire 12 also presents an upper ring surface 36 and a lower ring surface 38 opposite the upper ring surface 36. An upper corner 40 is located between the upper ring surface 36 and the upper portion 32 of the wire outer diameter surface 22, and a lower corner 42 is located between the lower ring surface 38 and the lower portion 34 of the wire outer diameter surface 22. The upper and lower corners 40, 42 of the wire 12 are sharp.

The coating 18 is not disposed on the corners 40, 42 of the wire 12. Thus, the upper and lower corners 40, 42 remain exposed. Preferably, the coating 18 is spaced from the upper corner 40 by the upper portion 32 of the wire outer diameter surface 22, and the coating 18 is spaced from the lower corner 42 by the lower portion 34 of the wire outer diameter surface 22. When the piston ring 10 is used in an internal combustion engine, the exposed and uncoated sharp corners 40, 24 help to control the oil consumption and reduce blowby gases during operation.

To improve wear resistance, a layer 43 of chrome can be disposed on the lower ring surface 38, as shown in FIG. 2A. The chrome layer 43 could have a thickness of 5 microns. Alternatively, all surfaces of the wire 12 can be nitrided, so that nitrogen is diffused into the wire 12.

Another aspect of the invention provides a method of manufacturing the piston ring 10. The method generally comprises the steps of providing the rail 14; disposing the coating 18 on the rail outer diameter surface 28; providing the wire 12; and disposing the rail 14 in the recess 16 of the wire 12. The method can also include applying the layer 43 of chrome to the lower ring surface 38, or nitriding all surfaces of the wire 12.

Yet another aspect of the invention provides a piston assembly 44 including the two-piece DLC coated piston ring 10. An example of the piston assembly 44 is shown in FIG. 3. The piston assembly 44 of the example embodiment includes a piston body portion 46 which includes a crown 48 having a plurality of ring grooves 50 extending circumferentially around the center axis A. The piston assembly 44 includes at least one of the piston rings 10 disposed in one of the ring grooves 50. In the example embodiment, the piston ring 10 is disposed in a top one of the ring grooves 50. The piston assembly 44 can also include other types of piston rings in the lower ring grooves 50.

Another aspect of the invention provides a method of manufacturing the piston assembly 44. The method includes providing the piston body portion 46, disposing at least one of the piston rings 10 on the piston body portion 46; and disposing the coating 18 including diamond-like carbon on the rail 14.

Obviously, many modifications and variations of the present invention are possible in light of the above teachings and may be practiced otherwise than as specifically described while within the scope of the claims. It is contemplated that all features described and of all embodiments can be combined with each other, so long as such combinations would not contradict one another.

What is claimed is:

1. A piston ring, comprising:
a wire formed of a metal material extending circumferentially around a center axis;
said wire presenting a wire outer diameter surface which includes a recess;
a rail formed of steel extending circumferentially around said center axis and being disposed in said recess of said wire;
said rail presenting a rail outer diameter surface; and
a coating including diamond-like carbon disposed on said rail outer diameter surface.

2. A piston ring according to claim 1, wherein said wire presents an upper ring surface and a lower ring surface opposite said upper ring surface; said wire includes a upper corner between said upper ring surface and an upper portion of said wire outer diameter surface; said wire includes a lower corner between said lower ring surface and a lower portion of said wire outer diameter surface; said coating is spaced from said upper corner by said upper portion of said wire outer diameter surface; and said coating is spaced from said lower corner by said lower portion of said wire outer diameter surface.

3. A piston ring according to claim 2, wherein said upper and lower corners of said wire are exposed and are sharp.

4. A piston ring according to claim 1, wherein said wire extends circumferentially around said center axis between opposite wire ends; said rail extends circumferentially around said center axis between opposite rail ends; a wire gap is located between said wire ends; a rail gap is located between said rail ends; and said rail gap is circumferentially misaligned with said wire gap.

5. A piston ring according to claim 1, wherein said coating presents a coating outer diameter surface; and said wire outer diameter surface and said coating outer diameter are convex.

6. A piston ring according to claim 1, wherein said wire outer diameter surface includes an upper portion spaced from a lower portion by said coating outer diameter surface; said rail outer diameter surface is disposed radially inwardly of said upper portion and said lower portion of said wire outer diameter surface; and said coating outer diameter surface is flush with said upper portion and said lower portion of said wire outer diameter surface.

7. A piston ring according to claim 1, wherein a layer of chrome is disposed on said wire.

8. A piston ring according to claim 1, wherein nitrogen is diffused into said wire adjacent said wire outer diameter surface.

9. A piston ring according to claim 1, wherein said wire extends circumferentially around said center axis between opposite wire ends;
said rail extends circumferentially around said center axis between opposite rail ends;
a wire gap is located between said rail ends;
a rail gap is located between said wire ends;
said rail gap is circumferentially aligned with said wire gap;
said coating presents a coating outer diameter surface;
said wire outer diameter surface and said coating outer diameter surface are outermost surfaces of said piston ring;
said wire outer diameter surface and said coating outer diameter surface are convex;
said wire outer diameter surface includes an upper portion spaced from a lower portion by said coating outer diameter surface;
said rail outer diameter surface is disposed radially inwardly of said upper portion and said lower portion of said wire outer diameter surface;
said coating outer diameter surface is flush with said upper portion and said lower portion of said wire outer diameter surface;
said wire presents an upper ring surface and a lower ring surface opposite said upper ring surface;
said wire includes an upper corner between said upper ring surface and said upper portion of said wire outer diameter surface;
said wire includes a lower corner between said lower ring surface and said lower portion of said wire outer diameter surface;
said upper and lower corners of said wire are sharp;
said coating is spaced from said upper corner by said upper portion of said wire outer diameter surface;
said coating is spaced from said lower corner by said lower portion of said wire outer diameter surface;
said coating is not disposed on said upper and lower corners of said wire;
said upper and lower corners of said wire are exposed; and
said coating is free of hydrogen.

10. A method of manufacturing a piston ring, comprising the steps of:
providing a rail formed of steel and extending circumferentially around a center axis, the rail presenting a rail outer diameter surface;
disposing a coating including diamond-like carbon on the rail outer diameter surface;
providing a wire formed of a metal material and extending circumferentially around a center axis, the wire presenting a wire outer diameter surface which includes a recess; and
disposing the rail in the recess of the wire.

11. A method according to claim 10, wherein the wire presents an upper ring surface and a lower ring surface opposite the upper ring surface; the wire includes an upper corner between the upper ring surface and an upper portion of the wire outer diameter surface; the wire includes a lower corner between the lower ring surface and a lower portion of the wire outer diameter surface; the coating is spaced from the upper corner by the upper portion of the wire outer diameter surface; and the coating is spaced from the lower corner by the lower portion of the wire outer diameter surface.

12. A method according to claim 10 including applying a layer of chrome to the wire.

13. A method according to claim 10 including nitriding the wire.

14. A piston assembly, comprising:
a piston body portion;
at least one piston ring disposed on said piston body portion;
each of said at least one piston ring including:
a wire formed of a metal material extending circumferentially around a center axis;
said wire presenting a wire outer diameter surface which includes a recess;
a rail formed of steel extending circumferentially around said center axis and being disposed in said recess of said wire;
said rail presenting a rail outer diameter surface; and
a coating including diamond-like carbon disposed on said rail outer diameter surface.

15. A piston assembly according to claim 14, wherein said wire extends circumferentially around said center axis between opposite wire ends; said rail extends circumferentially around said center axis between opposite rail ends; a wire gap is located between said wire ends; a rail gap is located between said rail ends; and said rail gap is circumferentially misaligned with said wire gap.

16. A piston assembly according to claim 14, wherein a layer of chrome is disposed on said wire.

17. A piston assembly according to claim 14, wherein said piston body includes a crown having a plurality of ring grooves extending circumferentially around said center axis; and each of said at least one piston ring is disposed in one of said ring grooves.

18. A method of manufacturing a piston assembly comprising the steps of:
providing a piston body portion;
disposing at least one piston ring on the piston body portion;
each of the at least one piston ring including a wire formed of a metal material extending circumferentially around a center axis, the wire presenting a wire outer diameter surface which includes a recess, a rail formed of steel extending circumferentially around the center axis and being disposed in the recess of the wire, and the rail presenting a rail outer diameter surface; and
disposing a coating including diamond-like carbon on the rail outer diameter surface.

19. A method according to claim 18 including a plurality of the piston rings; wherein the wire extends circumferentially around the center axis between opposite wire ends; the rail extends circumferentially around the center axis between opposite rail ends; a wire gap is located between the wire ends; a rail gap is located between the rail ends; and the rail gap is circumferentially misaligned with the wire gap.

20. A method according to claim 18 including applying a layer of chrome to the wire or nitriding the wire.
